(19) United States
(12) Patent Application Publication
(10) Pub. No.: US 2008/0145106 A1
(43) Pub. Date: Jun. 19, 2008

(54) IMAGE DEVELOPING UNIT AND IMAGE FORMING APPARATUS HAVING THE SAME

(75) Inventors: Sang Don LEE, Gwacheon-si (KR); Jin-Geun KWAK, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/871,236

(22) Filed: Oct. 12, 2007

(30) Foreign Application Priority Data
Dec. 18, 2006 (KR) 2006-129457

(51) Int. Cl. G03G 15/08

(52) U.S. Cl. 399/256

(57) ABSTRACT

An image developing unit and an image forming apparatus having the same. The image forming apparatus includes a body, an image developing unit including a frame having a developer supply part into which a developer is introduced, a developing roller rotatably installed on a developing roller support part provided in the frame, and a developer supply auger mounted in the developer supply part so as to provide the developing roller with the developer and formed with a reduction part having a reduced circumferential width, and an image transferring unit to transfer a visible image formed in the image developing unit onto a printing medium, wherein the developer supply auger is installed on the frame such that the reduction part is positioned corresponding to the developing roller support part. An interval between central axes of the developing roller and the developer supply auger becomes narrow, so that a developer is stably supplied to the developing roller.

### CROSS-REFERENCE TO RELATED APPLICATIONS

This application claims the benefit of Korean Patent Application No. 2006-129457, filed on Dec. 18, 2006, in the Korean Intellectual Property Office, the disclosure of which is incorporated herein in its entirety by reference.

### BACKGROUND OF THE INVENTION

1. Field of the Invention

The present general inventive concept relates generally to an image forming apparatus, and more particularly to, an image developing unit having an improved structure in which a developer can be stably supplied to a developing roller, and an image forming apparatus having the image developing unit.

2. Description of the Related Art

In general, an image forming apparatus may be classified into a mono image forming apparatus for forming black and white images, and a color image forming apparatus for forming color images. Currently, a variety of image forming apparatuses capable of forming mono or color images have been developed and used.

Among these image forming apparatuses, an electro-photographic type image forming apparatus is an apparatus in which light is irradiated onto a photoreceptor electrified with a predetermined electric potential such that an electrostatic latent image is formed on an outer circumferential surface of the photoreceptor, a toner serving as a developer is attached to the electrostatic latent image to create a visible image, and the visible image is then transferred and fixed on a printing medium, thereby printing an image. Such an electro-photographic type image forming apparatus has an image developing unit mounted inside a body for the purpose of developing images. The image developing unit includes a photoreceptor on which electrostatic latent images are formed, and a developing roller mounted to have a predetermined development gap with the photoreceptor and having a developer attached on an outer circumferential surface of the photoreceptor.

The developer used in developing may be divided into one-component and two-component developers. The one-component developer is conveyed on a developing roller after toner particles are electrified due to friction between the toner particles or between the toner particle and an electrifying member. Further, two-component developer is a developer in which magnetic carrier particles and non-magnetic toner particles of a plastic material are mixed at a proper mixture ratio. The two-component developer is electrified when the toner particles are mixed with the carrier particles, and then conveyed together with the carrier particles on a developing roller. Thus, there is an advantage in that the two-component developer is deteriorated lower than the one-component developer when being electrified.

An image developing unit using the two-component developer receives a toner supplied from a toner supply container changeably attached to a body. Toner particles supplied from the toner supply container are mixed with carrier particles by means of an agitation tool mounted inside the image developing unit, and electrified with an opposite polarity. The agitation tool includes a pair of augers. The first auger mixes and electrifies new toner particles with carrier particles while conveying the new toner particles in one direction. Further, the second auger is mounted to be spaced apart from a developing roller at a predetermined gap. The second auger uniformly supplies a mixed developer on a surface of the developing roller while conveying the mixed developer in the other direction.

Here, it is advantageous that the second auger is mounted to be adjacent to the developing roller, and spaced apart from the developing roller within a predetermined range (e.g., 2 mm) such that a spiral vane provided in the second auger does not directly agitate the developer attached to the developing roller. There is a problem in that, if an interval between the second auger and the developing roller becomes broader, the size of the image developing unit becomes larger, and the developer is not stably supplied to the developing roller, thereby producing an image defect.

However, the conventional image developing unit has a limitation in that the interval between the auger and the developing roller becomes narrow due to the structure of a frame for supporting the developing roller. That is, since a portion of the frame is positioned between the developing roller and the auger, the auger must be more distant from the developing roller such that the spiral vane cannot make contact with the frame.

Meanwhile, in order to increase the amount of developer supplied to the developing roller, a magnetic force of the developing roller may be increased. However, the increase of the magnetic force increases stress applied to the developer, and thus the life span of the developer may be reduced.

### SUMMARY OF THE INVENTION

The present general inventive concept provides an image developing unit, wherein the structure of an auger is improved such that an interval between the auger and a developing roller can be reduced, thereby stably supplying a developer to the developing roller, and an image forming apparatus having the image developing unit.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an image forming apparatus, which includes a body, an image developing unit installed in the body, and including a frame having a developer supply part into which a developer is introduced, a developing roller rotatably installed on a developing roller support part provided in the frame, and a developer supply auger mounted in the developer supply part so as to provide the developing roller with the developer and formed with a reduction part having a reduced circumferential width, and an image transferring unit for transferring a visible image formed in the image developing unit onto a printing medium, wherein the developer supply auger is installed on the frame such that the reduction part is positioned corresponding to the developing roller support part.

The developer supply auger may include a rotating shaft and a spiral vane provided on an outer circumferential surface of the rotating shaft.

The reduction part may be formed by partially reducing a radius of the spiral vane.

The image developing unit may include a sealing member provided between the developing roller support part and the developing roller.

A radius R of the spiral vane, a radius r of a reduced vane, a thickness t of a portion of the developing roller support part, a thickness d of the sealing member, and a gap g between the reduced vane and the developing roller support part can be determined by using the following formula

(R−r)≦(t+g+d)

The foregoing and/or other aspects and utilities of the present general inventive concept may also be achieved by providing an image forming apparatus, which includes a frame having a developer support part into which a developer is introduced, a developing roller rotatably attached to a developing roller support part provide in the frame, and a developer supply auger mounted in the developer supply part to supply a developer to the developing roller and provided with a reduction part having a reduced circumferential width, wherein the developer supply auger is attached to the frame such that the reduction part is positioned corresponding to the developing roller support part.

The foregoing and/or other aspects and utilities of the present general inventive concept may also be achieved by providing an image developing unit usable with an image forming apparatus, including a frame, a developing roller rotatably installed in the frame, and a developer supply auger rotatably installed into frame and having a first vane with a first dimension and a second vane with a second dimension smaller than the first dimension of the first vane so as to supply a developer to the developing roller.

The developer supply auger may include a rotation shaft, the first vane is disposed on a first portion of the rotation shaft, and the second vane is disposed on a second portion of the rotation shaft.

The second portion of the rotation shaft may correspond to end portions of the developing roller.

The first portion of the rotation shaft may correspond to a center portion of the developing roller.

The developing supply auger may include a rotation shaft, the first dimension comprises a first width from the rotation shaft, and the second dimension may include a second width from the rotation shaft.

The first vane may be spaced-apart from the developing roller by a first distance, and the second vane may be spaced-apart from the developing roller by a second distance longer than the first distance.

The first dimension may be greater than the second dimension.

The first dimension may include a first radius, and the second dimension may include a second radius smaller than the first radius.

The frame may include a developing roller support part in which the developing roller is rotatably installed, the first vane may be disposed from the developing roller support part by a first distance, and the second vane may be disposed from the developing roller support part by a second distance shorter than the first distance.

The frame may include a developing roller support part on which the developing roller is rotatably supported, and a difference between the first dimension and the second dimension may be determined according to a distance between the developing roller and a portion of the developing roller support part disposed between the developing roller and the developer supply auger, a thickness of the portion of the developing roller, and a distance between the second vane and the portion of the developing roller support part.

The foregoing and/or other aspects and utilities of the present general inventive concept may also be achieved by providing an image forming apparatus including a body having a photoreceptor, and an image developing unit installed in the body, and including a frame, and opening formed on to frame to communicate with the photoreceptor, a developing roller rotatably installed in the frame to supply a developer to the photoreceptor through the opening, and a developer supplier auger rotatably installed in the frame, and having a first vane with a first dimension and a second vane with a second dimension to supply a developer from an inside of the frame to the developing roller.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a side sectional view schematically illustrating an image forming apparatus according to an exemplary embodiment of the present general inventive concept;

FIG. 2 is a perspective view schematically illustrating an image developing unit of the image forming apparatus of FIG. 1;

FIG. 3 is a perspective view illustrating a developer supply auger of the image forming of FIG. 2;

FIG. 4 is a side sectional perspective view illustrating a portion of the image developing unit of the image forming apparatus of FIGS. 1-3; and

FIG. 5 is a side sectional view illustrating the portion of the image developing unit of the image forming apparatus of FIGS. 1-4.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

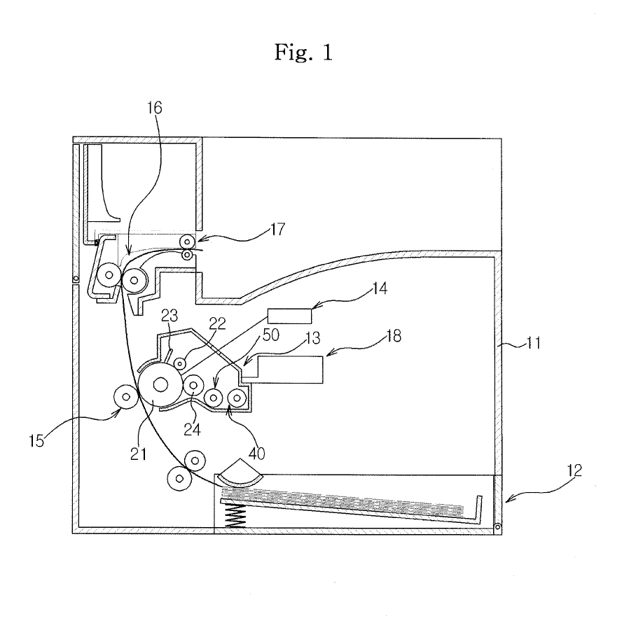

As illustrated in FIG. 1, an image forming apparatus according to an embodiment of the present general inventive concept includes a body 11 to form an exterior of the image forming apparatus, a printing medium supply unit 12 detachably mounted on a bottom of the body 11, an image developing unit 13 to form a visible image, an light emitting unit 14 to scan light onto the image developing unit 13, an image transfer unit 15 to transfer the visible image formed on the image developing unit 13 onto a printing medium supplied from the printing medium supply unit 12, an image fixing unit 16 to fix the visible image transferred onto the printing medium thereto, and a printing medium discharge unit 17 to discharge the printing medium on which printing is completed to an outside of the body 11.

Here, it is possible the printing medium supply unit 12, the light emitting unit 14, the image transfer unit 15, the image fixing unit 16 and the printing medium discharge unit 17 may be similar to conventional ones. Thus, detailed descriptions for the configurations and functions of these units will be omitted.

The image developing unit 13 includes a photoreceptor 21 on which an electrostatic latent image is formed by receiving light emitted from the light emitting unit 14, an electrifying roller 22 to electrify the photoreceptor 21 with a predetermined electric potential, a cleaning blade 23 to come into contact with a surface of the photoreceptor 21 to remove a developer remaining the surface thereof, a developing roller 24 to supply a developer to the photoreceptor on which an electrostatic latent image, developer agitation and supply augers 40 and 50 to agitate and electrify a developer and to supply the electrified developer to the developing roller 24. A toner supply container 18 to supply a toner to an interior of the image developing unit 13 is connected to one side thereof.

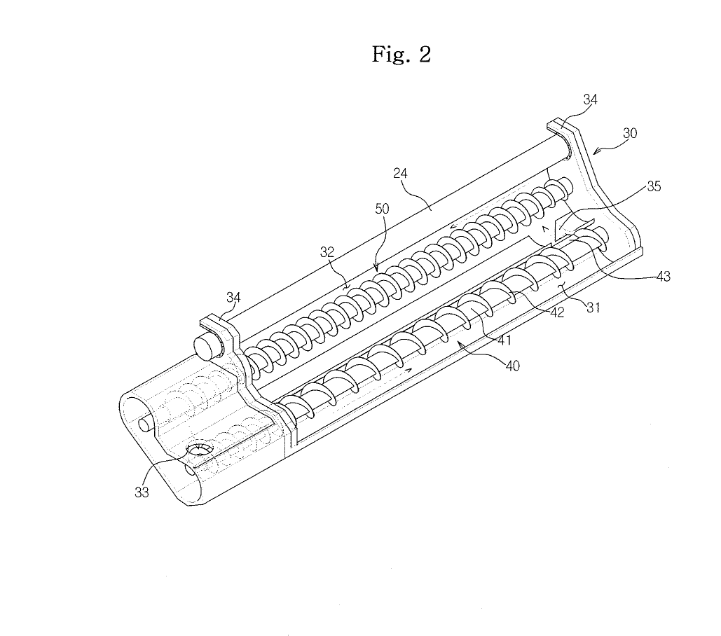

As illustrated in FIG. 2, the developer agitation and supply augers 40 and 50 are rotatably mounted on a frame 30. The frame 30 is provided with an agitation part 31 having a space to accommodate the developer agitation auger 40, a developer supply part 32 having a space to accommodate the developer supply auger 50, a toner supply hole 33 connected to the toner supply container 18 to receive a toner from the toner supply container 18 and a developing roller support part 34 to rotatably support the developing roller 24.

The developer agitation auger 40 includes a rotating shaft 41 rotatably coupled to the frame 30 and a spiral vane 42 provided at an outer circumferential surface of the rotating shaft 41. The developer agitation auger 40 conveys a developer including toner and carrier particles to one side of the frame 30 while agitating the developer. Toner particles supplied through the toner supply hole 33 are electrified while being agitated with the developer existing inside the frame 30 by the developer agitation auger 40. A conveying rib 43 is provided at one side of the developer agitation auger 40. The conveying rib 43 is positioned to a side of a developer conveying hole 35 to connect the agitation part 31 and the developer supply part 32 such that the developer agitated in the developer agitation part 31 is conveyed to the developer supply part 32 through the developer conveying hole 35. A gear part (not illustrated) to receive a driving force transmitted from an external driving source (not illustrated) is provided at one end portion of the developer agitation auger 40.

Here, the toner supplying hole 33 is disposed to supply the toner to a first end of the developer agitations auger 40, and the developer conveying hole 35 is disposed to receive the developer from a second end of the developer agitation auger 40. The developer agitation auger 40 mixes the supplied toner particles and the carrier particles to generate a developer, and transfer the developer toward the developer conveying hole 35. The first end and the second end of the developer agitation auger 40 are disposed opposite to each other in a rotation axis of the developer agitation auger 40.

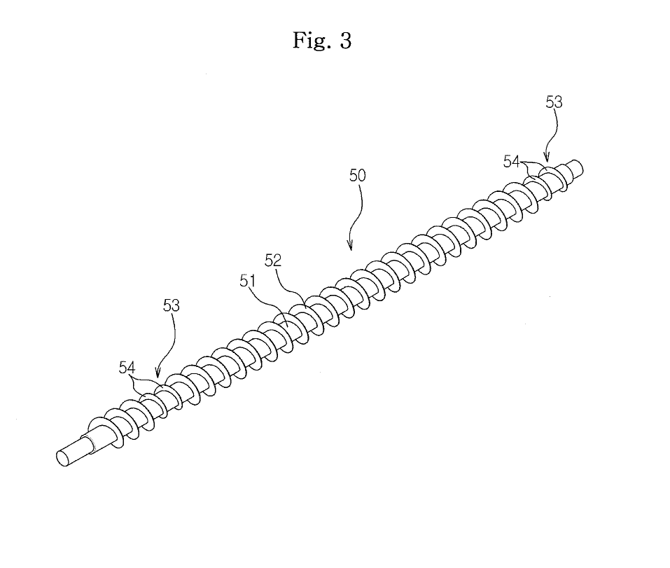

As illustrated in FIG. 3, the developer supply auger 50 includes a rotating shaft 51 rotatably coupled to the frame 30 and a spiral vane 52 provided at an outer circumferential surface of the rotating shaft 51. A reduction part 53 having a reduced circumferential width of a portion of the developer supply auger 50 is provided thereto. The reduction part 53 is provided at a position corresponding to the developing roller support part 34 positioned between the developing roller 24 and the developer supply auger 50. The reduction part 53 is formed by reducing a radius of a portion of the spiral vane 52. When the developer supply auger 50 is coupled to the frame 30, the reduction part 53 is positioned at a lower portion of the developing roller support part 34, thereby allowing the spiral vane 52 of the developer supply auger 50 to be closer to the developing roller 24. The developer supply auger 50 conveys to the other side of the frame 30 a developer conveyed to the developer supply part 32 through the developer conveying hole 35 from the developer agitation part 31, and supplies the developer to the developing roller 24. A gear part (not illustrated) to receive a driving force transmitted from an external driving source is provided at one end portion of the developer supply auger 50.

The reduction part 53 includes a second spiral vane 54 having a smaller dimension, for example, a size and/or a radius, than the spiral vane 53. A spacing between vanes of the second spiral vane 54 may be the same as the vanes of the spiral vane 52. It is possible that the spacing of the vanes of the second spiral vane 54 is different from (smaller) the vanes of the spiral vane 52. The reduction part 53 may be disposed end portions of the rotating shaft 51 or between vanes of the spiral vane 52. The reduction part 53 may be disposed end portions of the developing roller 24. The reduction part 53 may be disposed on the rotation shaft 51 adjacent to the developing roller support part 34. The reduction part 53 is disposed on a first length of the rotating shaft 51 shorter than a second length of the rotating shaft 51 on which the spiral vane 52 is disposed.

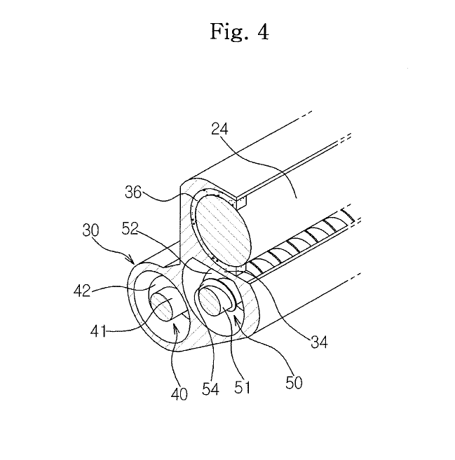

As illustrated in FIG. 4, the developing roller 24 is rotatably supported by the developing roller support part 34. A sealing member 36 is provided in a gap between the developing roller 24 and the developing roller support part 34 except an opening portion of the developing roller 24 opened to the photoreceptor 21 such that a developer attached to the developing roller 24 can be prevented from being leaked to the outside of the frame 30. The sealing member 36 is made of an elastic material such as sponge.

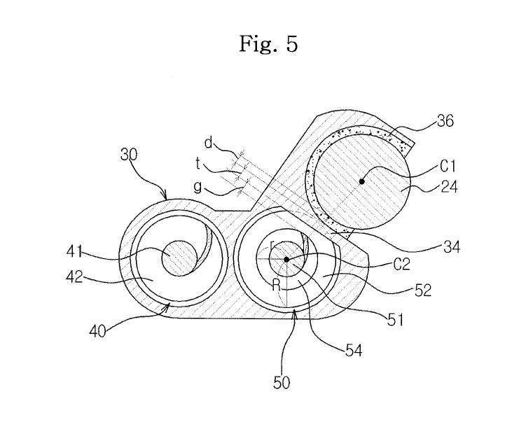

As illustrated in FIG. 5, the developer supply auger 50 is spaced apart from the developing roller 24 within a predetermined range (e.g., 2 mm) such that the spiral vane 52 of the developer supply auger 50 cannot directly agitate the developer attached to the developing roller 24. Here, if an interval between the spiral vane 52 of the developer supply auger 50 and the developing roller 24 is increased, the supply of the developer to the developing roller 24 is not stable. For this reason, the spiral vane 52 of the developer supply auger 50 may be disposed adjacent to the developing roller 24 as close as possible. To this end, a reduced vane 54 formed by reducing the radius of vanes of the spiral vane 52 is positioned at a lower portion of the developing roller support part 34 to be close thereto, so that an interval between central axes C1 and C2 of the developing roller 24 and the developer supply auger 50 can be reduced.

Following Expression 1 is derived from a radius R of the spiral vane 52, a radius r of a reduced vane 54, a thickness t of a portion of the developing roller support part 34, a thickness d of the sealing member 36, and a gap g between the reduced vane 54 and the developing roller support part 34;

(R−r)≦(t+g+d)

The radius r of the reduced wing 54 is set through such a method, thereby approaching the spiral vane 52 of the developer supply auger 50 closer to the developing roller 24, so that a developer can be stably supplied to the developing roller 24.

Here, a sum of the thickness t of a portion of the developing roller support part 34, the thickness d of the sealing member 36, and the gap g between the reduced vane 54 and the developing roller support part 34a can be a distance between the developing roller 24 and the reduced vane 54. It is also possible that the thickness d of the sealing member 36 may be a distance between the developing roller 24 and the spiral vane 52.

In the present invention, in a case where a structure to support the developing roller 24 is not positioned between the developing roller 24 and the developer supply auger 50, the variable t in the Expression 1 may not be the thickness of the portion of the developing roller support part 34 positioned between the developing roller 24 and the developer supply auger 50 but the thickness of a portion of the frame 30 positioned between the developing roller 24 and developer supply auger 50.

Further, the reduction part 53 of the developer supply auger 50 may be formed by omitting the spiral vane 52 unlike the aforementioned embodiment.

As described above, according to the present general inventive concept, when attaching a developer supply auger to a frame having a developing roller attached thereto, a reduction part with a reduced size of the developer supply auger is positioned at a lower portion of the frame positioned between the developing roller and the developer supply auger to be close to the frame, thereby approaching a spiral vane of the developer supply auger closer to the developing roller.

Accordingly, a developer can be stably supplied to the developing roller, and it is unnecessary to increase a magnetic force of the developing roller for the purpose of stably supplying the developer as a prior art. For this reason, stress applied to the developer can be reduced, thereby increasing the life span of the developer.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus comprising:
a body;
an image developing unit installed in the body and including a frame having a developer supply part into which a developer is introduced, a developing roller rotatably installed on a developing roller support part provided in the frame, and a developer supply auger mounted in the developer supply part so as to provide the developing roller with the developer and formed with a reduction part having a reduced circumferential width; and
an image transferring unit to transfer a visible image formed in the image developing unit onto a printing medium,
wherein the developer supply auger is installed on the frame such that the reduction part is positioned corresponding to the developing roller support part.

2. The image forming apparatus as claimed in claim 1, wherein the developer supply auger includes a rotating shaft and a spiral vane provided on an outer circumferential surface of the rotating shaft.

3. The image forming apparatus as claimed in claim 2, wherein the reduction part is formed by partially reducing a radius of the spiral vane.

4. The image forming apparatus as claimed in claim 3, wherein the image developing unit further comprises a sealing member provided between the developing roller support part and the developing roller.

5. The image forming apparatus as claimed in claim 4, wherein a radial difference between the spiral vane and the reduced vane can be determined by the following formula;
(R−r)≦(t+g+d)
where radius R of the spiral vane, a radius r of a reduced vane, a thickness t of a portion of the developing roller support part, a thickness d of the sealing member, and a gap g between the reduced vane and the developing roller support part.

6. An image developing unit usable with an image forming apparatus comprising:
a frame having a developer support part into which a developer is introduced;
a developing roller rotatably attached to a developing roller support part provide in the frame; and
a developer supply auger mounted in the developer supply part to supply a developer to the developing roller and provided with a reduction part having a reduced circumferential width,
wherein the developer supply auger is installed on the frame such that the reduction part is positioned corresponding to the developing roller support part.

7. The image developing unit as claimed in claim 6, wherein the developer supply auger includes a rotating shaft and a spiral vane provided on an outer circumferential surface of the rotating shaft.

8. The image developing unit as claimed in claim 7, wherein the reduction part is formed by partially reducing a radius of the spiral vane.

9. The image developing unit as claimed in claim 8, further comprising:
a sealing member provided between the developing roller support part and the developing roller.

10. The image developing unit as claimed in claim 9, wherein a radial difference between the spiral vane and the reduced vane can be determined by the following formula;
(R−r)≦(t+g+d)
where radius R of the spiral vane, a radius r of a reduced vane, a thickness t of a portion of the developing roller support part, a thickness d of the sealing member, and a gap g between the reduced vane and the developing roller support part.

11. An image developing unit usable with an image forming apparatus, comprising:
a frame;
a developing roller rotatably installed in the frame; and
a developer supply auger rotatably installed in the frame and having a first vane with a first dimension and a second vane with a second dimension smaller than the first dimension of the first vane so as to supply a developer to the developing roller.

12. The image developing unit as claimed in claim 11, wherein:
the developer supply auger comprises a rotation shaft;
the first vane is disposed on a first portion of the rotation shaft; and
the second vane is disposed on a second portion of the rotation shaft.

13. The image developing unit as claimed in claim 12, wherein the second portion of the rotation shaft corresponds to end portions of the developing roller.

14. The image developing unit as claimed in claim 12, wherein the first portion of the rotation shaft corresponds to a center portion of the developing roller.

15. The image developing unit as claimed in claim 11, wherein the first dimension is greater than the second dimension.

16. The image developing unit as claimed in claim 11, wherein the first dimension comprises a first radius, and the second dimension comprises a second radius smaller than the first radius.

17. The image developing unit as claimed in claim 11, wherein:
the frame comprises a developing roller support part in which the developing roller is rotatably installed;
the first vane is disposed from the developing roller support part by a first distance; and
the second vane is disposed from the developing roller support part by a second distance shorter than the first distance.

18. The image developing unit as claimed in claim 11, wherein:
the frame comprises a developing roller support part on which the developing roller is rotatably supported; and
a difference between the first dimension and the second dimension is determined according to a distance between the developing roller and a portion of the developing roller support part disposed between the developing roller and the developer supply auger, a thickness of the portion of the developing roller, and a distance between the second vane and the portion of the developing roller support part.

19. An image forming apparatus comprising:
a body having a photoreceptor; and
an image developing unit installed in the body, and including a frame, and opening formed on to frame to communicate with the photoreceptor, a developing roller rotatably installed in the frame to supply a developer to the photoreceptor through the opening, and a developer supplier auger rotatably installed in the frame, and having a first vane with a first dimension and a second vane with a second dimension to supply a developer from an inside of the frame to the developing roller.
